(19) United States
(12) Patent Application Publication
(10) Pub. No.: US 2024/0403190 A1
(43) Pub. Date: Dec. 5, 2024

(54) ENABLING BRANCH RECORDING WHEN BRANCH RECORDING CONFIGURATION VALUES SATISFY A PREDETERMINED CONDITION

(71) Applicant: Arm Limited, Cambridge (GB)

(72) Inventor: Michael John Williams, Cambridge (GB)

(73) Assignee: Arm Limited, Cambridge (GB)

(21) Appl. No.: 18/697,460

(22) PCT Filed: Aug. 11, 2022
(86) PCT No.: PCT/GB2022/052096

§ 371 Date: Mar. 30, 2024

(30) Foreign Application Priority Data
Oct. 5, 2021 (GB) 2114255.9

(51) Int. Cl. G06F 11/36; G06F 11/34

(52) U.S. Cl. CPC G06F 11/3636; G06F 11/348

(57) ABSTRACT

An apparatus comprises reset circuitry to perform a cold reset and to perform a warm reset by resetting a subset of state that is reset the cold reset, and branch recording circuitry to perform branch recording to store, in branch record storage circuitry, information about processed branch instructions. The branch recording circuitry determines whether warm and cold branch recording configuration values held in at least one register satisfy a predetermined condition; and when the warm and cold branch recording configuration values fail to satisfy the predetermined condition, branch recording is disabled. The branch record storage circuitry is configured to make the information about the processed branch instruction available for diagnostic analysis. The cold reset comprises resetting both of the warm and cold branch recording configuration values, and the warm reset comprises resetting the warm branch recording configuration value and leaving the cold branch recording configuration value unchanged.

The present technique relates to the field of data processing.

A data processing apparatus may be arranged to perform branch recording, which is a technique that captures information about processed branch instructions, allowing later software to perform processes—e.g. diagnostic, debugging and/or profiling processes—using the captured information.

Viewed from an example of the present technique, there is provided an apparatus comprising:
processing circuitry to process instructions;
reset circuitry responsive to a cold reset trigger event to perform a cold reset by resetting the processing circuitry and responsive to a warm reset trigger event to perform a warm reset by resetting a subset of state that is reset in response to the cold reset trigger event; and
branch recording circuitry to perform branch recording to store, in branch record storage circuitry, information about processed branch instructions;
wherein the branch recording circuitry is configured to:
   determine whether warm and cold branch recording configuration values held in at least one register satisfy a predetermined condition; and
   when the warm and cold branch recording configuration values satisfy the predetermined condition, enable the branch recording,
wherein the branch record storage circuitry is configured to make the information about the processed branch instruction available for diagnostic analysis, and
wherein the cold reset comprises resetting both of the warm and cold branch recording configuration values, and the warm reset comprises resetting the warm branch recording configuration value and leaving the cold branch recording configuration value unchanged.

Viewed from another example of the present technique, there is provided a method comprising:
processing instructions on processing circuitry;
performing, in response to a cold reset trigger event, a cold reset by resetting the processing circuitry;
performing, in response to a warm reset trigger event, a warm reset by resetting a subset of state that is reset in response to the cold reset trigger event;
determining whether warm and cold branch recording configuration values held in at least one register satisfy a predetermined condition; and
when the warm and cold branch recording configuration values satisfy the predetermined condition, enabling branch recording, the branch recording comprising storing, in branch record storage circuitry, information about processed branch instructions,
wherein the method comprises making the information about the processed branch instruction available for diagnostic analysis, and
wherein the cold reset comprises resetting both of the warm and cold branch recording configuration values, and the warm reset comprises resetting the warm branch recording configuration value and leaving the cold branch recording configuration value unchanged.

Further aspects, features and advantages of the present technique will be apparent from the following description of examples, which is to be read in conjunction with the accompanying drawings, in which:

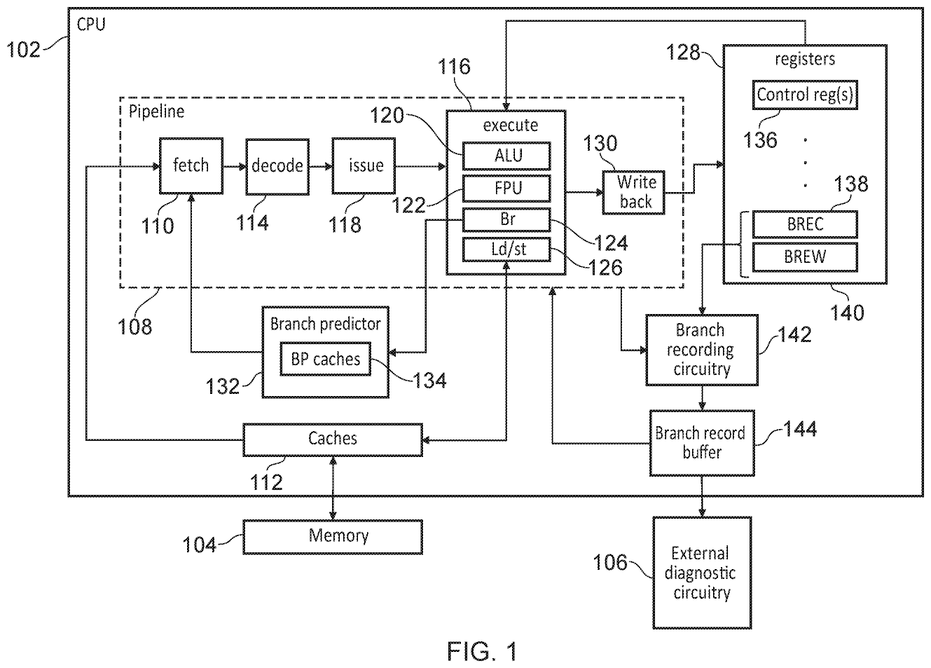

FIG. 1 schematically illustrates a data processing system in which the present technique can be implemented;

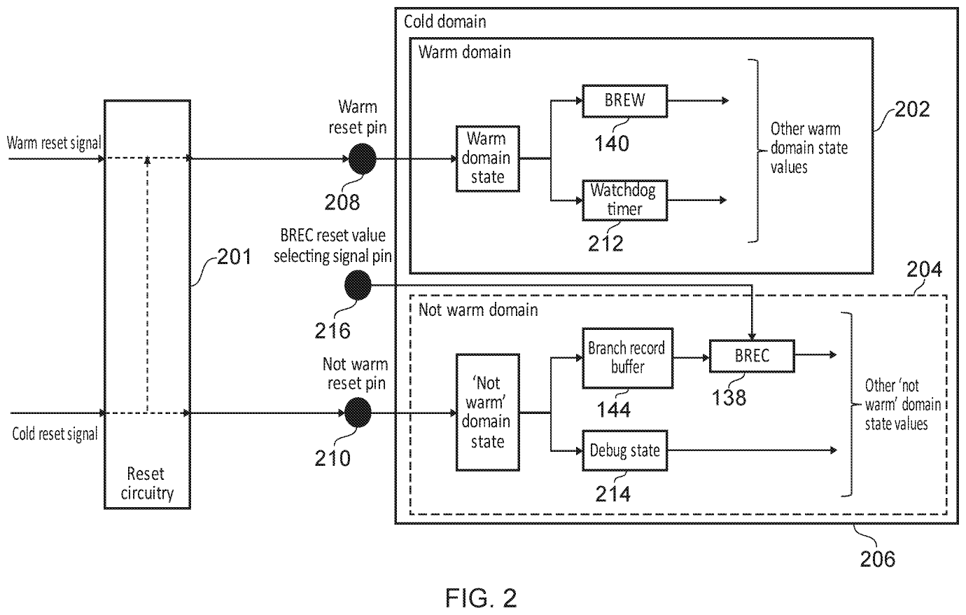

FIG. 2 schematically illustrates warm, not-warm and cold reset domains;

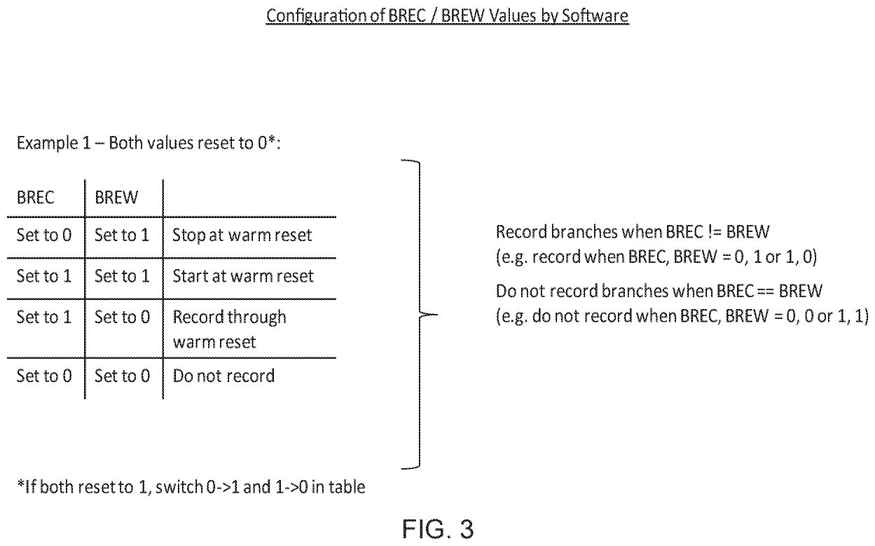

FIG. 3 is a table showing an example of how the warm and cold branch recording configuration values (BREW, BREC) could be configured to control the operation of the branch recording circuitry;

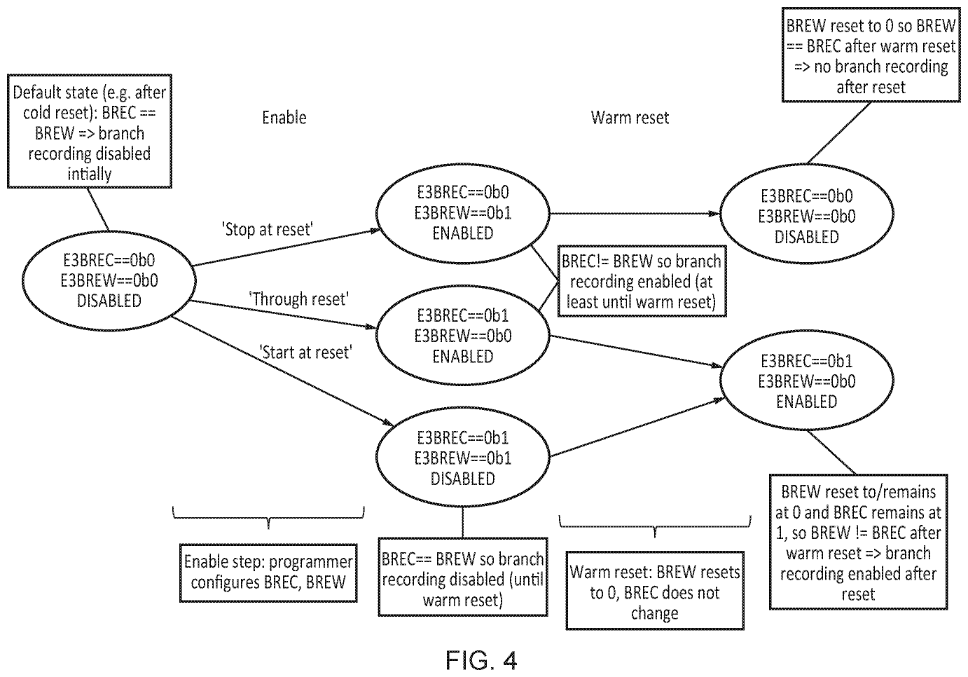

FIG. 4 is a diagram showing what happens to the warm and cold branch recording configuration values (BREW, BREC) after configuration by software, and after a warm reset, in accordance with the example shown in FIG. 3;

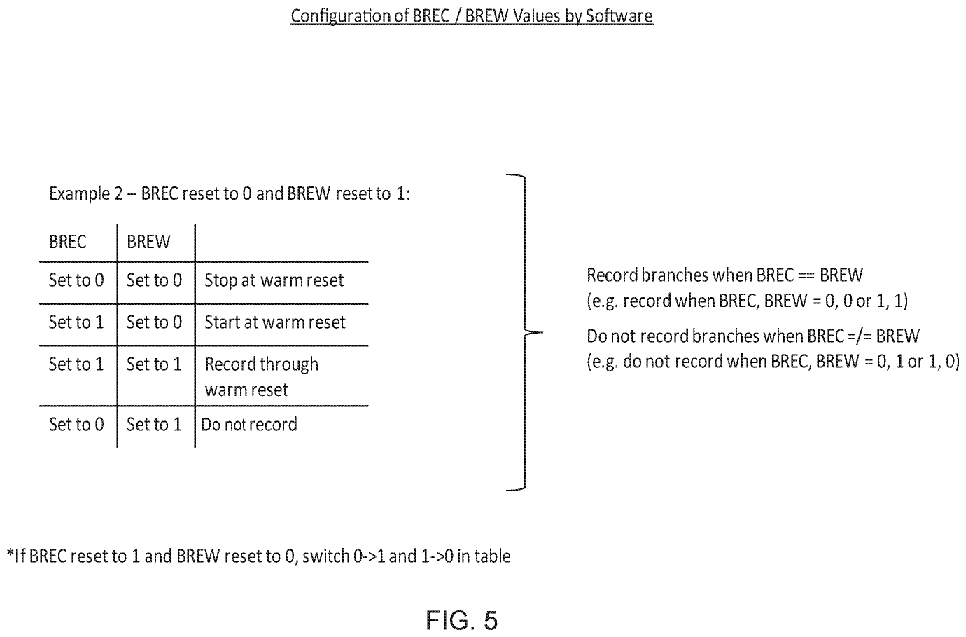

FIG. 5 is a table showing another example of how the warm and cold branch recording configuration values (BREW, BREC) could be configured to control the operation of the branch recording circuitry;

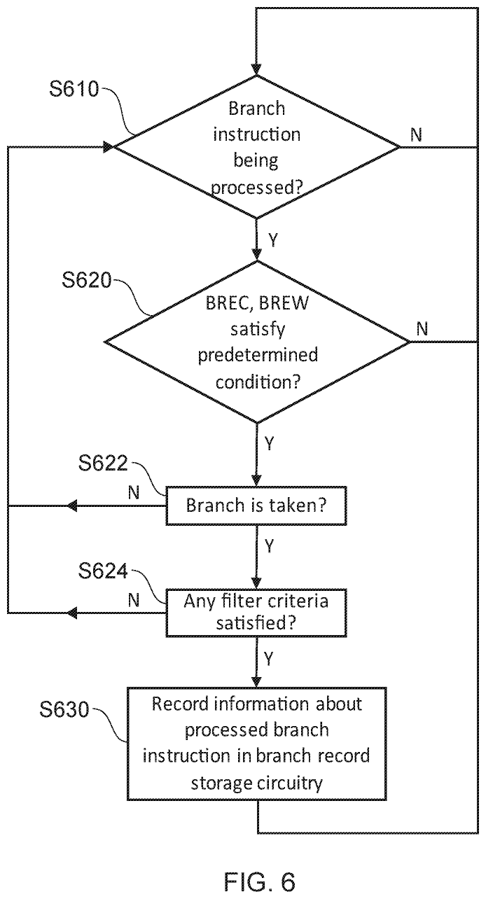

FIG. 6 is a flow diagram illustrating an example of a method carried out by the branch recording circuitry, under the control of the warm and cold branch recording configuration values (BREW, BREC);

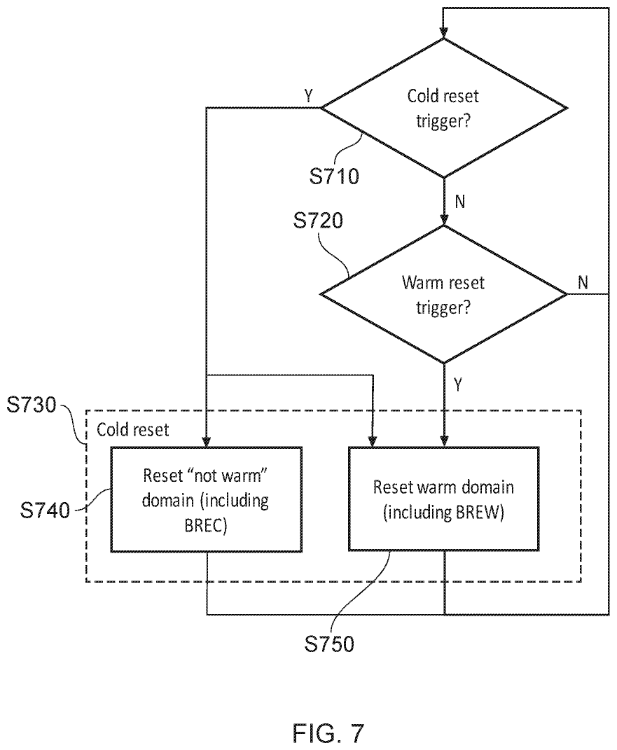

FIG. 7 is a flow diagram illustrating an example of a reset process;

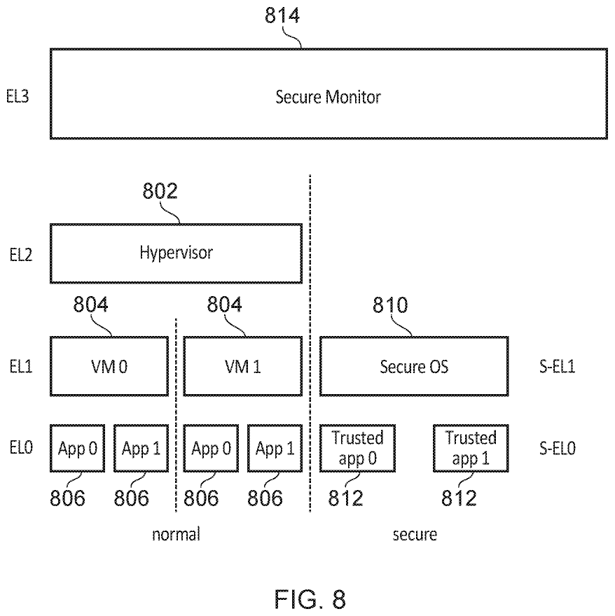

FIG. 8 schematically illustrates various processes which may be executed in a data processing system; and

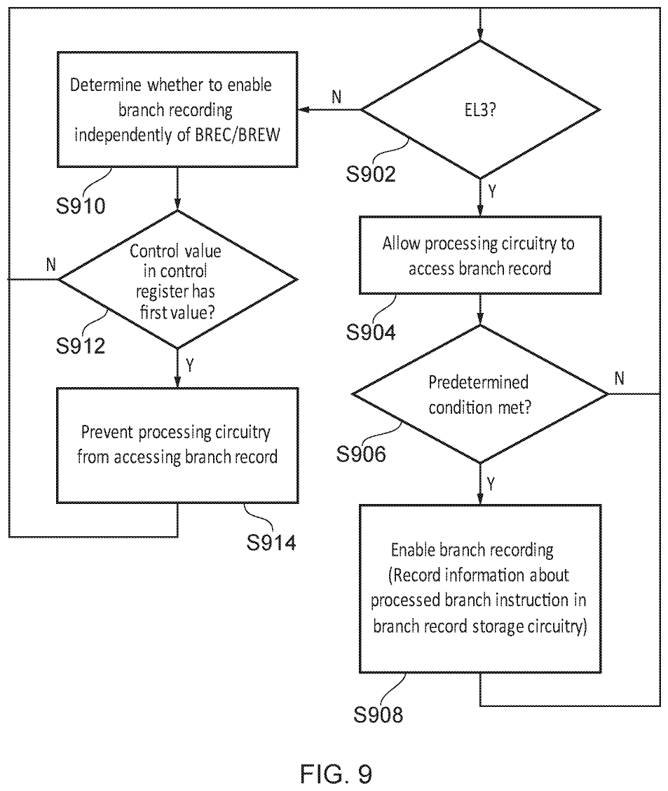

FIG. 9 is a flow diagram illustrating an example of determining whether to allow processes at a less privileged execution level than a given execution level (EL3 in the example of FIG. 9) to access the information stored in the branch record buffer.

Before discussing example implementations with reference to the accompanying figures, the following description of example implementations and associated advantages is provided.

In accordance with one example configuration there is provided an apparatus comprising processing circuitry to process instructions. For example, the processing circuitry may be a central processing unit (CPU), a processing pipeline within a CPU, or any other circuitry within the apparatus capable of processing instructions.

The apparatus also comprises reset circuitry responsive to a cold reset trigger event to perform a cold reset by resetting the processing circuitry, and responsive to a warm reset trigger event to perform a warm reset by resetting a subset of state that is reset in response to the cold reset trigger event. For example, a reset could involve setting the values of any state subject to the reset to a default (reset) value (e.g. this could be 0 or 1—in some cases there may be some items of state reset to 0 and other items of state reset to 1). The warm reset can be considered to be a partial reset, involving resetting some but not all (e.g. a proper subset) of the state that is reset in a cold reset. In this context, “state” can be understood to refer to information remembered (e.g. stored) by components of the processing circuitry—for example, this could include data stored in storage circuits such as registers, a cache or memory, but can also include any information recorded by flip-flops within components of the processing circuitry.

In the apparatus, there is also provided branch recording circuitry for performing branch recording to store, in branch record storage circuitry, information about processed branch instructions. The branch recording circuitry is configured to determine whether warm and cold branch recording configuration values held in at least one register satisfy a predetermined condition, and, when the warm and cold branch recording configuration values satisfy the predetermined condition, enable the branch recording.

For example, when branch recording is enabled, the branch recording circuitry may detect that a branch instruction (e.g. a program flow altering instruction which, when executed, can cause the processing circuitry to branch to another instruction other than the instruction following the program flow altering instruction sequentially in the program order) is being processed when it is fetched by fetch circuitry within the processing circuitry, when it is decoded by decode circuitry within the processing circuitry, when it is issued by issue circuitry within the processing circuitry, or when it is executed by execution circuitry within the processing circuitry. However, it will be appreciated that these are all merely examples, and that the branch recording circuitry may be arranged to detect that a branch instruction is being processed at any stage/part of the processing circuitry. When a particular branch instruction is detected, when branch recording is enabled, whether information about the branch is stored in the branch recording circuitry may depend on factors other than the warm and cold branch recording configuration values (e.g. on whether the branch is taken, or on whether filter criteria are satisfied as explained further below). Hence, when branch recording is enabled, this means that branch recording in general is enabled to allow information on certain processed branches to be recorded, but this does not imply that every branch processed while branch recording is enabled needs to have information recorded in the branch record storage circuitry.

The warm and cold branch recording configuration values may, for example, be a pair of values held in one or more registers, and could be any value (e.g. 1, 0 or any other value), although it will be appreciated that the warm and cold branch recording configuration values could comprise more than two values. The predetermined condition may depend on values to which the warm and cold branch recording configuration values are set, and in some examples the predetermined condition comprises a condition to be satisfied by both of the warm and cold branch recording configuration values (e.g. a condition to be satisfied by the pair of branch recording configuration values together). At least in some states of the processing circuitry, the predetermined condition being satisfied indicates that the branch recording circuitry should enable branch recording. When the predetermined condition is unsatisfied, then branch recording is disabled.

When branch recording is enabled, then information about processed branch instructions is stored to branch record storage circuitry, which could be a dedicated storage structure or could be a data structure (e.g. a circular buffer) in memory, for example. The branch record storage circuitry is configured to make the information about the processed branch instruction available for diagnostic analysis. The information stored to the branch record buffer can be useful in diagnostic processes, such as debugging or code profiling, and the branch record buffer may be arranged to make this information available to diagnostic processes performing such analysis. The information about the branches could be made available for diagnostic analysis by allowing diagnostic software or a debug tool to read the information from the branch record storage circuitry, or by outputting the recorded branch information over a trace port to an external debugger or computer for performing diagnostic analysis.

In the apparatus of the present technique, the cold reset comprises resetting both of the warm and cold branch recording configuration values, and the warm reset comprises resetting the warm branch recording configuration value and leaving the cold branch recording configuration value unchanged. For example, the state that is reset in response to a cold reset trigger may comprise both the cold branch recording configuration value and the warm branch recording configuration value, while the state that is reset in response to a warm reset trigger (e.g. the subset of the state that is reset in response to the cold reset trigger) may comprise the warm branch recording configuration value but not the cold branch recording configuration value. Hence, the value of the warm branch recording configuration value may be reset to its default/reset value during a warm reset, while the cold branch recording configuration value maintains the value it had prior to the warm reset trigger being received/detected (which could be its default/reset value, but could also be a different value)—the cold branch recording configuration value is not affected by a warm reset.

The inventors of the present technique realised that it can be useful for diagnostic processes to be able to inspect information about branches processed around a warm reset. For example, this could allow for post-mortem diagnostics (e.g. inspecting information captured for branches executed prior to the reset, for example to identify the cause of the reset), or even for performing diagnostics on any reset firmware which might be executed by the processing circuitry immediately after a warm reset. However, reset signals are typically asynchronous, meaning that they can occur at any time, which makes it difficult to predict when a reset will occur. This can make it difficult to control whether branch recording is performed around a warm reset.

The present technique addresses these difficulties by providing two control values: a warm branch recording configuration value and a cold branch recording configuration value, which can be used (by determining whether the pair of branch recording configuration values meet a predetermined condition) to control whether branch recording is enabled or disabled around reset. In particular, by providing two control values, one of which is reset in response to both warm and cold resets (the warm branch recording configuration value), and one of which is reset in response to a cold reset but not in response to a warm reset (the cold branch recording configuration value), the warm and cold branch recording configuration values can be set to control when branch recording will start and stop around a warm reset (for example, by setting the warm and cold branch recording configuration values in consideration of the predetermined condition and of the fact that the warm branch recording configuration value will be reset at a warm reset). In addition, the present technique can be implemented without a significant increase in circuit area and power usage. Hence, the apparatus enables more informative diagnostic information to be captured around a warm reset, without significantly increasing the circuit cost in terms of an increased circuit area.

In some examples, the branch recording circuitry is configured to determine whether the warm and cold branch recording configuration values held in the at least one register satisfy the predetermined condition based on a comparison of the warm branch recording configuration value with the cold branch recording configuration value.

This can be a particularly advantageous way to implement the branch recording circuitry of the present technique, since a performing a simple comparison of a pair of values requires less circuit area (e.g. compared to more a complex set of logic for decoding the arbitrary state of the bits in each of the branch recording configuration values), and so incurs less cost.

In some examples, the predetermined condition comprises one of: the warm and cold branch recording configuration values being equal, and the warm and cold branch recording configuration values being different. For example, the predetermined condition may be considered to be satisfied when both the warm and cold branch recording configuration values have the same value (e.g. both could have a value of 1, or both could have a value of 0, although it will be appreciated that in other examples the branch recording configuration values could have values other than 0 or 1). Alternatively, the predetermined condition may be considered to be satisfied when the warm branch recording configuration value has a different value to the cold branch recording configuration value (e.g. one of the values could be 1 and the other could be 0, although (again) it will be appreciated that in other examples the branch recording configuration values could have values other than 0 or 1).

In this way, the present technique can be implemented using simple comparison circuitry, thus requiring only a small increase in circuit area.

Another advantage of evaluating the predetermined condition based on whether the warm and cold branch recording configuration values are equal or not equal is that this means there can be multiple different combinations of settings of the warm and cold branch recording configuration values that may each satisfy, or not satisfy, the predetermined condition. For example, the equals condition can be satisfied when the two configuration values are either both 0 or both 1, and the not equals condition can be satisfied when the two configuration values are either 0 and 1, or 1 and 0. Providing multiple settings corresponding to “enabled” or multiple settings corresponding to “disabled” can be useful because it means that the user can configure the configuration values with different settings providing a different enabled/disabled status for branch recording after warm reset, even if the enabled/disabled status before the warm reset is to be the same for each of those settings (or conversely, the user can configure the configuration values with different settings for the enabled/disabled status before warm reset, even if the desired behaviour for enabled/disabled status of the branch recording after the warm reset is to be the same). In contrast, an approach (e.g. using a single enable/disable bit) which provides only a single configuration setting corresponding to branch recording being enabled and a single configuration setting corresponding to branch recording being disabled would have less flexibility in configuring different options before and after the warm reset.

In some examples, the at least one register is configurable by software to set the warm and cold branch recording configuration values to one of a plurality of states, and the warm branch recording configuration value has one of a warm configured value and a warm reset value, and the warm reset and cold reset both comprise resetting the warm branch recording configuration value to the warm reset value. For example, a programmer may configure the warm and cold branch recording configuration values by including, in software, one or more instructions to update the values stored in the at least one register. The warm reset value is the value to which the warm branch recording configuration value returns to after a warm or cold reset (for example, if the warm and cold resets comprise resetting the warm branch recording configuration value to 0, then the warm reset value is 0; likewise, if the warm and cold resets comprise resetting the warm branch recording configuration value to 1 then the warm reset value is 1. It will be appreciated, however, that other examples of the warm reset value are also possible). The warm configured value may be a value different to the warm reset value. Moreover, it will be appreciated that the plurality of “states” described above describe what the software writes to the at least one register before the warm reset happens; the value of the warm branch recording configuration value can change at warm reset (e.g. from the warm configured value to the warm reset value)—thus, the state set by the software does not necessarily remain through a warm reset.

By allowing software to set the warm and cold branch recording configuration values, this allows a programmer to set controls for whether branch recording is performed before and after the warm reset. This can be particularly useful, since it allows the programmer to control the diagnostic information gathered by the branch recording circuitry.

In some examples, the plurality of states comprise a start-at-reset state, wherein the branch recording circuitry is responsive to the warm and cold branch recording configuration values indicating the start-at-reset state to, in response to the reset circuitry performing the warm reset, enable the branch recording. For example, the start-at-reset state (e.g. mode or configuration) of the warm and cold branch recording configuration values causes the branch recording circuitry to not perform branch recording prior to a warm reset (e.g. the predetermined condition is not met prior to a warm reset), but to perform branch recording after a warm reset (e.g. the warm branch recording configuration value is reset on a warm reset, so that the predetermined condition is met following the warm reset).

The start-at-reset state can be advantageous, because it can cause the branch recording circuitry to capture information about the reset process itself (e.g. recording information about branches in the reset firmware which executes after the warm reset to identify or respond to the cause of the warm reset event), without wasting power or reducing performance by performing branch recording prior to the warm reset that might not be needed, and that may (at least in the case of a small, circular branch record buffer) be over-written with any of the more recent information gathered after the warm reset (in some implementations, enabling branch recording may sometimes limit the maximum performance achievable by the processing circuitry to less than when branch recording is disabled, for example because when branch recording is enabled the branch recording circuitry may impose a limit on how many branches are allowed to be processed in one cycle by the processing circuitry). For example, a developer may wish to select the start-at-reset state if performing diagnostic analysis to analyse performance or correct functioning of the reset firmware.

In some examples, the start-at-reset state is indicated by the warm branch recording configuration value having the warm configured value and the cold branch recording configuration value having a first value, the branch recording circuitry is configured to determine that the predetermined condition is satisfied when the warm branch recording configuration value has the warm reset value and the cold branch recording configuration value has the first value, and
the branch recording circuitry is configured to determine that the predetermined condition is unsatisfied when the warm branch recording configuration value has the warm configured value and the cold branch recording configuration value has the first value. With this setting, given that the cold branch recording configuration value retains the first value after the warm reset event, the transition on a warm reset from the warm configured value to the warm reset value causes the predetermined condition to become satisfied after the warm reset when it was unsatisfied before the warm reset, so that branch recording will become enabled at the warm reset.
   For example:
if the warm reset value is 0 and the predetermined condition is satisfied when the warm and cold branch recording configuration values are different (not equal), then the start-at-reset state can be configured by setting the cold branch recording configuration value to 1 (e.g. the first value is 1) and the warm branch recording configuration value to 1 (e.g. the warm configured value is 1);
if the warm reset value is 1 and the predetermined condition is satisfied when the warm and cold branch recording configuration values are different (not equal), then the start-at-reset state can be configured by setting the cold branch recording configuration value to 0 (e.g. the first value is 0) and the warm branch recording configuration value to 0 (e.g. the warm configured value is 0);
if the warm reset value is 1 and the predetermined condition is satisfied when the warm and cold branch recording configuration values are the same (equal), then the start-at-reset state can be configured by setting the cold branch recording configuration value to 1 (e.g. the first value is 1) and the warm branch recording configuration value to 0 (e.g. the warm configured value is 0); and
if the warm reset value is 0 and the predetermined condition is satisfied when the warm and cold branch recording configuration values are the same (equal), then the start-at-reset state can be configured by setting the cold branch recording configuration value to 0 (e.g. the first value is 0) and the warm branch recording configuration value to 1 (e.g. the warm configured value is 1).

In some examples, the plurality of states comprise a stop-at-reset state, wherein the branch recording circuitry is responsive to the warm and cold branch recording configuration values indicating the stop-at-reset state to, in response to the reset circuitry performing the warm reset, disable the branch recording. For example, the stop-at-reset state (e.g. mode or configuration) of the warm and cold branch recording configuration values causes the branch recording circuitry to perform branch recording up until a warm reset (e.g. the predetermined condition is met prior to a warm reset), but not to perform branch recording after a warm reset (e.g. the warm branch recording configuration value is reset on a warm reset, so that the predetermined condition is no longer met following the warm reset).

The stop-at-reset state can be advantageous, because it allows information about the program flow immediately before the warm reset (e.g. information about any firmware configured to execute in the aftermath of a reset) to be reconstructed, allowing any issues in the code executed immediately before the warm reset (for example, including the issue which caused the warm reset) to be diagnosed. By disabling branch recording after the warm reset, this prevents the branch records recorded before the warm reset being overwritten by branch records associated with branches executed after the warm reset.

In some examples, the stop-at-reset state is indicated by the warm branch recording configuration value having the warm configured value and the cold branch recording configuration value having a second value, the branch recording circuitry is configured to determine that the predetermined condition is satisfied when the warm branch recording configuration value has the warm configured value and the cold branch recording configuration value has the second value, and the branch recording circuitry is configured to determine that the predetermined condition is unsatisfied when the warm branch recording configuration value has the warm reset value and the cold branch recording configuration value has the second value. For example, the second value may be any value which is different to the first value. With this setting, given that the cold branch recording configuration value retains the second value after the warm reset event, the transition on a warm reset from the warm configured value to the warm reset value causes the predetermined condition to become unsatisfied (e.g. stop being satisfied) after the warm reset when it was satisfied before the warm reset, so that branch recording will become disabled at the warm reset.

For example:
if the warm reset value is 0 and the predetermined condition is satisfied when the warm and cold branch recording configuration values are different (not equal), then the stop-at-reset state can be configured by setting the cold branch recording configuration value to 0 (e.g. the second value is 0) and the warm branch recording configuration value to 1 (e.g. the warm configured value is 1);
if the warm reset value is 1 and the predetermined condition is satisfied when the warm and cold branch recording configuration values are different (not equal), then the stop-at-reset state can be configured by setting the cold branch recording configuration value to 1 (e.g. the second value is 1) and the warm branch recording configuration value to 0 (e.g. the warm configured value is 0);
if the warm reset value is 1 and the predetermined condition is satisfied when the warm and cold branch recording configuration values are the same (equal), then the stop-at-reset state can be configured by setting the cold branch recording configuration value to 0 (e.g. the second value is 0) and the warm branch recording configuration value to 0 (e.g. the warm configured value is 0); and
if the warm reset value is 0 and the predetermined condition is satisfied when the warm and cold branch recording configuration values are the same (equal), then the stop-at-reset state can be configured by setting the cold branch recording configuration value to 1 (e.g. the second value is 1) and the warm branch recording configuration value to 1 (e.g. the warm configured value is 1).

In some examples, the plurality of states comprise a record-through-reset state, wherein the branch recording circuitry is responsive to the warm and cold branch recording configuration values indicating the record-through-reset state to perform branch recording both before and after the reset circuitry has performed the warm reset. For example, the record-through-reset state (e.g. mode or configuration) of the warm and cold branch recording configuration values causes the branch recording circuitry to perform branch recording up until a warm reset (e.g. the predetermined condition is met prior to a warm reset), and then to continue branch recording after the warm reset (e.g. the warm reset does not change the either of the branch recording configuration values, so that the predetermined condition continues to be met following the warm reset). For example, the record-through-reset state instructs the branch recording circuitry to enable the branch recording on both sides (before and after) the warm reset.

The record-through-reset configuration may be useful to a developer if there is diagnostic information of interest to be captured both before and after warm reset (e.g. if the developer wants to test whether the reset firmware behaves correctly in the event of some specific condition arising with the software executed before the warm reset, and so they need some information on the branches in the software before the warm reset to probe whether that event happened).

In some examples, the record-through-reset state is indicated by the warm branch recording configuration value having the warm reset value and the cold branch recording configuration value having the first value, and the branch recording circuitry is configured to determine that the predetermined condition is satisfied when the warm branch recording configuration value has the warm reset value and the cold branch recording configuration value has the first value. With this setting, given that the cold branch recording configuration value retains the first value after the warm reset event and the warm branch recording configuration value retains the warm reset value after the warm reset event, the warm reset does not change whether the predetermined condition is met. Hence, the predetermined condition remains satisfied after the warm reset when it was satisfied before the warm reset, so that branch recording will be enabled both before and after the warm reset.

For example:
if the warm reset value is 0 and the predetermined condition is satisfied when the warm and cold branch recording configuration values are different (not equal), then the record-through-reset state can be configured by setting the cold branch recording configuration value to 1 (e.g. the first value is 1) and the warm branch recording configuration value to 0;
if the warm reset value is 1 and the predetermined condition is satisfied when the warm and cold branch recording configuration values are different (not equal), then the record-through-reset state can be configured by setting the cold branch recording configuration value to 0 (e.g. the first value is 0) and the warm branch recording configuration value to 1;
if the warm reset value is 1 and the predetermined condition is satisfied when the warm and cold branch recording configuration values are the same (equal), then the record-through-reset state can be configured by setting the cold branch recording configuration value to 1 (e.g. the first value is 1) and the warm branch recording configuration value to 1; and
if the warm reset value is 0 and the predetermined condition is satisfied when the warm and cold branch recording configuration values are the same (equal), then the record-through-reset state can be configured by setting the cold branch recording configuration value to 0 (e.g. the first value is 0) and the warm branch recording configuration value to 0.

Although specific examples of how the warm and cold branch recording configuration values may be configured are given above for each of the start-at-reset, stop-at-reset and record-through-reset states, it will be appreciated that these are merely examples, in which it is assumed that the warm and cold branch recording configuration values can each take a value of either 1 or 0. In other examples, such as where the warm and cold branch recording configuration values are not confined to a single bit, other predetermined conditions may be set.

In some examples, the cold branch recording configuration value has one of a cold configured value and a cold reset value, and the cold reset comprises resetting the cold branch recording configuration value to the cold reset value.

In some examples, the branch recording circuitry is configured to determine that the predetermined condition is unsatisfied when the warm branch recording configuration value has the warm reset value and the cold branch recording configuration value has the cold reset value. This means that the default state for the warm and cold branch recording configuration values after a cold reset may be to disable branch recording. For example, in a system where the stop-at-reset, start-at-reset and/or record-through-reset states are implemented as discussed above, in order for the default state after cold reset to be to disable branch recording, the cold configured value may be the first value and the cold reset value may be the second value.

However, in other examples where the cold branch recording configuration value has one of a cold configured value and a cold reset value, if it is considered acceptable to enable branch recording after a cold reset, in a system where the stop-at-reset, start-at-reset and/or record-through-reset states are implemented as discussed above, the cold configured value may be the second value, and the cold reset value may be the first value.

In this way, the apparatus can be arranged such that the default after a cold reset is no branch recording (e.g. branch recording is disabled), to avoid recording branch information before the software has a chance to set the warm and cold branch recording configuration values. This can reduce the amount of power wasted (e.g. in performing branch recording when it is not needed) and can also, in systems where branch recording around a reset is controlled by higher-privileged software, be more secure. With this setting, given that the cold branch recording configuration value retains the cold reset value after the warm reset event and the warm branch recording configuration value retains the warm reset value after the warm reset event, so the warm reset does not change whether the predetermined condition is met. Hence, the predetermined condition remains unsatisfied after the warm reset when it was unsatisfied before the warm reset, so that branch recording is not performed.

In some examples, the value set to the cold branch recording configuration value in response to a cold reset may be fixed and predetermined, either being the first value or the second value as mentioned above.

However, in other examples, in response to the cold reset trigger event, the reset circuitry may reset the cold branch recording configuration value to one of a first value and a second value specified by a reset value selecting signal. Hence, whether or not branch recording is enabled or disabled after a cold reset could vary depending on a signal supplied at the time of the cold reset trigger event. This can allow control over whether branch recording is enabled by default or disabled by default after a cold reset. For example, the reset value selecting signal can be connected to circuit logic outside of the cold reset domain, or via a pin on the integrated circuit to an external circuit which supplies the reset value selecting signal.

In some examples, the processing circuitry is responsive to a control value held in a control register having a first value to prevent the branch record storage circuitry from being accessed while the processing circuitry is operating at a less privileged execution level than a given execution level. For example, the processing circuitry may be configured to operate in one of a plurality of execution levels (e.g. these can also be referred to as privilege levels or exception levels), with processes executing at each execution level being permitted to access a different subset of information/state stored within or accessible to the processing circuitry. For example, processes executing at a more privileged execution level may be permitted to access storage structures or memory regions which are not accessible to lower-privileged processes (e.g. processes being executed at a lower execution level). These storage structures may, in some examples, include the branch record storage circuitry, which may be made inaccessible to processes executing at a less privileged execution level than a given privilege level at least some of the time, for example under the control of the control value stored in the control register. For example, the control register may hold state which controls various functions of the processing circuitry, and the control value may be a single value (e.g. a single bit) among the state stored in the control register, or it could be a multi-bit field where at least one encoding of that field indicates that the branch record storage circuitry should not be accessible from the less privileged execution level. Alternatively, the control register may be a register dedicated to holding the control value. The first value of the control value may not necessarily be the same as the first value of the cold branch recording configuration value in the example described above, and the control value can be set (e.g. by software operating at the given execution level) to control whether the branch record storage circuitry can be accessed by less privileged processes operating at an execution level with less privilege than the given execution level.

In this way, the security of the system can be improved, by preventing processes operating (being executed) with less privilege than a given execution level from accessing branch records generated at that execution level (e.g. reset firmware may be executed at the given execution level), thus making it more difficult for untrusted code to obtain information about the higher-privilege code (e.g. malicious programs may be able to use the information stored in the branch record storage circuitry to deduce sensitive information, especially since the information recorded by the branch recording circuitry may be sufficient to allow the program flow to be reconstructed). This means that information about branch instructions processed at the given execution level can still be recorded if desired—which can be useful in diagnostics—without compromising the security of the system.

In some examples, the branch recording circuitry is responsive to the processing circuitry operating at a given execution level to determine whether to enable the branch recording based on the warm and cold branch recording configuration values, and responsive to the processing circuitry operating at a less privileged execution level than the given execution level to determine, independently of the warm and cold branch recording configuration values, whether the branch recording is enabled or disabled. For example, the warm and cold branch recording configuration values may only control branch recording for branches processed at the given execution level (or a more privileged execution level), and some other control may be implemented to control branch recording when executing at a less privileged execution level than the given execution level. For example, the control mechanism utilising the warm and cold branch configuration values can be specific to a particular execution level and execution levels with less privilege can have a different control mechanism (e.g. using a single enable value specifying whether branch recording is enabled or disabled).

By providing a separate mechanism for controlling the branch recording at the more privileged level, it is not necessary to grant access to the warm and cold branch recording configuration values to less privileged execution levels. Moreover, providing warm and cold branch recording configuration values may not be justified for less privileged execution levels, as less privileged code will not execute immediately after a warm reset, so it may be acceptable for software to configure an enable/disable value after the warm reset to control the branch recording behaviour—this means a simpler configuration option such as a single enable/disable value can be used. The use of the warm/cold branch recording configuration values is particularly useful for the more privileged code that executes immediately after the warm reset, and so by the time that more privileged code is able to make a configuration change to branch recording configuration information, it may already have executed a reasonable number of instructions for which it would be useful to be able to provide diagnostic information (for example, instructions in the reset firmware that executes immediately after the warm reset). By using the warm/cold reset configuration values, this makes it practical to diagnose issues associated with the code that executes immediately after the warm reset, which might not be practical if software configuration of an enable value was required after the warm reset before branch recording could start. Further, in some particular examples the warm and cold branch recording configuration values may also be made inaccessible to the processes executing at a less privileged execution level than the given execution level, so that less-privileged (and, potentially, untrusted) programs cannot control whether or not branch recording is performed for processes at the given execution level.

In some examples, the information about the processed branch instruction comprises information allowing a program flow of processed instructions to be reconstructed. For example, the information held in the branch recording storage circuitry may allow the program flow to be reconstructed by a program flow analyser who has a copy of the program (e.g. by providing information indicative of which branch instructions were executed and the outcomes and/or targets of the executed branches)—the stored information need not, itself, be complete record of program flow.

In this way, the branch recording performed by the branch recording circuitry can provide information which will help with diagnostics (e.g. to help identify any problems in the code or the processor).

In some examples, the information about the processed branch instruction comprises at least one of: an instruction address of a processed taken branch instruction, and a target address of the processed taken branch instruction. The information stored in the branch recording storage circuitry for the processed branch instruction may include any one of these pieces of information, or both of these pieces of information. It will be appreciated that there may also be other information stored in the branch recording circuitry as well, and that the choice of exactly what information should be recorded will depend on the particular implementation, for example depending on the diagnostic or debug program that is intended to be used.

In this way, the behaviour of a processed branch instruction can be identified, thus—for example—allowing the program flow to be reconstructed, which in turn helps with diagnostics.

In some cases, filtering criteria could be set to control which types of branches have information recorded in the branch recording storage circuitry. For example, the types could include indirect branches, branch-with-link instructions which cause an indication of a return address to be stored to a link register, or function return branch instructions which branch to the return address indicated in the link register. The filtering criteria could specify which of these types should have information recorded in the branch recording storage circuitry when branch recording is enabled. Therefore, it is not essential for every branch to have information recorded in the branch recording storage circuitry, even when branch recording is enabled using the warm and cold branch recording configuration values.

In some examples, the branch record storage circuitry is configured to make the information about the processed branch instruction available to at least one of: external diagnostic hardware; and a diagnostic process executing on the processing circuitry. There are many different ways to perform diagnostics or debugging for a processor, and these can involve providing a diagnostic program to be executed by the processing circuitry itself, or providing external (e.g. external to (separate from) the processing circuitry itself, e.g. off-chip) diagnostic hardware (e.g. circuitry) to execute a diagnostic program, which may involve the external diagnostic hardware probing components of the processing hardware, including the branch record storage circuitry. For example, external diagnostic hardware could include specialised diagnostic (e.g. debug) hardware or an external computer running diagnostic software. In either situation, the information stored in the branch record storage circuitry can be made available to the diagnostic process.

Using external hardware dedicated to diagnostics can allow a larger amount of branch information (and indeed any other information which may be captured by the processing circuitry and provided to the external hardware) to be analysed (e.g. if the external hardware has more storage space for diagnostic information such as branch records than is available to the processing circuitry), can provide greater functionality (since it does not rely on resources available to the processing circuitry), and can allow the diagnostic process to be carried out even if a catastrophic error means that processing circuitry cannot be used. Hence, it can be very useful to make the information stored in the branch record storage circuitry available to external diagnostic hardware. However, diagnostic processes can also be performed on-chip (e.g. by the processing circuitry), so it can also be advantageous to allow such processes executing on the processing circuitry to access the stored branch information.

In some examples, both of the warm and cold branch recording configuration values are held in the same register. While it is possible for each of the warm and cold branch recording configuration values to be held in separate registers (e.g. they could each be held in a dedicated register), in some implementations both values may be held within the same register. For example, this could be a dedicated register for storing the warm and cold branch recording configuration values, or a control register which also stores other control state. For example, the warm and cold branch recording configuration values could be held in the same control register storing the control value described above, in implementations where this control value is provided. The warm and cold branch recording configuration values could each have any size or take any value, but in some particular examples each of the warm and cold branch recording configuration values could comprise a single bit within the same register.

This approach of recording both of the warm and cold branch recording configuration values in the same registers can be particularly advantageous by making it quicker for these values to be to configured. In particular, a single system register updating instruction may specify new values for multiple bits stored in a single system register, whereas if the warm and branch recording configuration values were held in multiple different registers then this may require two separate system register updating instructions, each specifying one of the registers, to be executed in order to update the values. This approach may also simplify access control in implementations where access to the warm and cold branch recording configuration values is restricted to a particular execution level.

The reset circuitry may be responsive to the warm reset trigger event to inhibit resetting of the branch record storage circuitry. Hence, the branch record storage circuitry may be left unchanged in response to the warm reset. The branch record storage circuitry can be within a cold reset domain which is reset in response to the cold reset trigger event but is not reset in response to the warm reset trigger event. This allows any branch information recorded in the branch record storage circuitry to remain accessible following a warm reset.

In some examples, the cold reset trigger event comprises a power-on event. For example, this could be in response to a power button being pressed to turn the processing circuitry on after it has been shut down. However, other examples of cold trigger events are also possible.

In some examples, the warm reset trigger event comprises a timeout signal generated in response to a watchdog counter elapsing. For example, a watchdog counter (e.g. watchdog timer) may be used to check whether the processing circuitry is operating properly. The timer may be set to a given value and allowed to count down over time. When the processing circuitry is operating correctly, it may periodically reset the counter (e.g. set it to its initial value), so that the watchdog counter only elapses if the computer is not operating properly. If the watchdog timer does elapse, it may generate an interruption and trigger the processing circuitry to perform corrective or diagnostic actions, including performing a warm reset. However, it will be appreciated that a watchdog event (e.g. the watchdog counter elapsing) is just one example of a warm reset trigger event, and other examples are also possible.

In some examples, the reset circuitry is responsive to each of a plurality of different warm reset trigger events to reset a different subset of the state that is reset in response to the cold reset trigger event. For example, there may be two or more warm reset domains containing different subsets of the state reset in a cold reset, and these two or more reset domains may be provided in addition to a cold domain encompassing all of the state reset in a cold reset.

Particular embodiments will now be described with reference to the figures.

FIG. 1 shows a data processing system in which the present technique could be implemented. The data processing system shown in FIG. 1 includes a central processing unit (CPU) 102 in communication with memory 104 and external diagnostic circuitry 106, although it will be appreciated that there may be other elements in the data processing system which are not shown in the figure.

The CPU 102 includes a processor pipeline 108, which comprises a number of pipeline stages for processing instructions. In particular, the pipeline 108 includes a fetch stage (fetch circuitry) 110, which fetches (e.g. reads) instructions from the caches 112, and passes them on to the decode stage 114. For example, the caches 112 may include multiple levels of cache, each cache holding a subset of the data and instructions stored in the memory 104. When the fetch stage 110 fetches an instruction from the caches 112, the instruction may already be stored in the highest level cache (e.g. the cache closest to the fetch stage 110—this could be a “level one” cache, although it is also possible for the cache levels to be labelled differently, so that the level one cache is the cache closest to memory 104), for example if that instruction has been fetched previously, or if it has been pre-fetched into the cache in advance. Alternatively, the instruction may not be present in the highest level cache, in which case it may need to be fetched from memory or a lower-level cache into the highest level cache, before being returned to the fetch stage 110.

Once the fetch stage has received an instruction, it passes it on to the decode stage (decode circuitry/decoder) 114, which decodes the instruction to generate control signals which control the execute stage (execution circuitry) 116 to execute the instruction. The issue stage (issue circuitry) 118 then controls when the decoded instruction (e.g. the control signals generated by the decode circuitry) is issued to the execute stage 116 for execution, and the execute stage 116 is responsive to the decoded instruction (e.g. responsive to the control signals) to execute the instruction.

The execute stage 116 includes multiple execution units, such as:
as an arithmetic logic unit (ALU) 120 for carrying out arithmetic operations in response to arithmetic instructions such as ADD, SUBTRACT, etc.;
a floating point unit (FPU) 122, for carrying out operations on floating point operands;
a branch unit (Br) 124 to execute branch instructions; and
a load/store unit (Id/st) 126 for performing load operations to load data from memory 104 (optionally via the caches 112) into a set of registers 128, and store operations to store data from the registers 128 into memory. For example, the load/store unit 126 may load data into the registers 128 in response to decoded load instructions, and may store data in response to decoded store instructions.

The pipeline 108 also includes a writeback stage (writeback circuitry) 130 to write the results of data processing operations performed by the execute stage 116 to the registers 128. The pipeline 108 is an example of processing circuitry to process instructions.

The register file 128 comprises a plurality of registers, each of which is a temporary storage structure for storing data of a given size. In the example of FIG. 1, the register file 128 includes one or more control registers 136, which store information for controlling the operation of one or more elements of the CPU. The register file also stores two branch recording configuration values 138, 140, which are examples of a warm branch recording configuration value (BREW) 140 and a cold branch recording configuration value (BREC) 138. Other registers (not shown) are also provided in the register file 128, for holding input and result operands for operations performed by the execution circuitry 116.

The CPU 102 also includes a branch predictor 132, which makes predictions about branch instructions on the basis of branch prediction information stored in one or more branch predictor caches 134. For example, the branch predictor 132 may predict the outcomes (e.g. taken or not taken) of branch instructions, and/or may predict the targets (e.g. the target address of a target instruction) of branch instructions. The branch predictor caches 134 may be updated in response to signals, received by the branch unit 124, indicative the outcomes and target addresses of executed branch instructions.

Also provided in the CPU 102 is branch recording circuitry 142 which is configured to read the branch recording configuration values 138, 140 and, when the branch recording configuration values meet a predetermined condition (e.g. have given values), to enable branch recording. When branch recording is enabled, information about executed branch instructions can be recorded in a branch record buffer 144. In particular, the branch record buffer 144 may store, for a given branch instruction whose outcome is taken, an instruction address of the processed branch instruction (e.g. a memory address indicating where the instruction is stored), and/or a target address of the processed branch instruction. Not taken branches do not need to have information stored in the branch record buffer 144, as it can be implicit that branches which do not appear in the branch record were not taken. Such information about processed branch instructions can be useful in diagnostic operations (e.g. operations to determine the cause of an error that has occurred, such as debugging operations). Therefore, the branch record buffer 144 is configured to make its contents available to inspection by the external diagnostic circuitry 106, which uses the stored information to diagnose problems encountered by the CPU. The branch record buffer 144 may also (or alternatively) make its contents available to a diagnostic process being executed by the execution circuitry 116. The branch record buffer 144 is an example of the branch record storage circuitry mentioned earlier, and is configured to make the information about the processed branch instruction available for diagnostic analysis. In other examples, the branch records recorded when branch recording is enabled could be written to the memory system and so the caches 112 and memory 104 may function as the branch record storage circuitry.

An example of a situation in which information about executed branch instructions might be useful to the external diagnostic circuitry 106 or a diagnostic process is around a warm reset of all or part of the CPU 102. For example, this could be a warm reset, in which a subset (including the warm branch recording configuration value (BREW) 140) of the state stored in the components of the CPU is reset (e.g. this could be in response to a watchdog timer elapsing, or in response to certain kinds of errors occurring). It can be useful for a diagnostic process to consider information about branch instructions which were executed in the cycles preceding a warm reset trigger (e.g. an event which triggers a warm reset), since this can give an indication of the events which lead to the warm reset being triggered. It can also be useful to record information about branch instructions processed immediately after the reset (e.g. branch instructions in reset firmware), to diagnose any problems with the reset code itself.

However, the branch record buffer 144 has a limited size—for example, it may be implemented as a small circular buffer—and expanding the size of the branch record buffer 144, which may only be used for diagnostic processes, and not for normal processing by the processor pipeline 108, may not be justified, given the additional cost this would incur in terms of increased circuit area. Therefore, the number of branch instructions for which information can be stored in the branch record buffer 144 is limited. It can therefore be useful to control when branch recording by the branch recording circuitry is enabled: for example, it can be useful to control whether branch recording should stop when a reset is triggered (e.g. not recording information for branch instructions processed after the reset), so that a larger number of the branch instructions executed in the time preceding the reset can be recorded (by preventing information relating to older branch instructions from being overwritten by information relating to branch instructions processed after the reset signal). This also avoids wasting power by performing branch recording when it is not needed. On the other hand, it can also be useful to start branch recording at a reset. For example, if the intention is to diagnose problems in the reset procedure itself, it can be a waste of power to perform branch recording before the reset occurs; thus, controlling the branch recording circuitry 142 to start branch recording at a reset can save power. Also, in some cases performing branch recording may be invasive, affecting the behaviour of the processing circuitry. For example, if the branch recording circuitry 142 can handle recording for a limited number of branches at a time, to avoid missing recording information about executed branches, when branch recording is enabled the number of branches that can be executed in a single cycle by the branch unit 124 could be limited to the number that can be supported by the branch recording circuitry 142. Therefore, it may be desirable to avoid enabling branch recording at times when the information being gathered by the branch recording circuitry 142 is not of interest to the user, to avoid unnecessarily limiting performance.

In some circumstances, however, a programmer may consider it beneficial to record branch information both before and after a reset, or indeed may decide that branch recording can be disabled (e.g. to save power).

The BREC and BREW values 138, 140 are, therefore, provided, to control branch recording around a warm reset. The BREW value 140 is configured to be reset by both warm and cold resets, while the BREC value 138 is configured to be reset by cold resets only, and a programmer can set the values of each register to control when the branch recording circuitry 142 performs branch recording.

The BREC and BREW values 138, 140 could each be stored in separate a register, or they could both be stored in the same register. For example, each of the BREC and BREW values could be a single bit (e.g. 1 or 0) provided within one of the control registers 136.

FIG. 2 illustrates warm, not-warm and cold reset domains. As shown in the figure, a CPU may be split into a warm domain 202, which is reset during a warm reset (in response to signals provided by a warm reset pin 208), and a not-warm domain 204, which is not reset during a warm reset, but which is reset during a cold reset (in response to signals provided by a not-warm reset pin 210). In a cold reset, all of the state in the warm domain 202 and all of the state in the not-warm domain 204 are reset, so that the cold domain 206 of state can be considered to be a domain encompassing both the warm domain 202 and the not-warm domain 204.

The data processing system also includes reset circuitry 201 which drives a warm reset pin 208 and a not-warm reset pin 210. In particular, the reset circuitry 210 is responsive to both warm reset signals (generated in response to a warm reset trigger event) and cold reset signals (generated in response to a cold reset trigger event) to drive the warm reset pin 208 to reset all of the state in the warm domain 202. On the other hand, reset circuitry 210 is responsive to cold reset signals (but not warm reset signals) to drive the cold not-warm reset pin 210 to reset the state in the not-warm domain 204. The reset circuitry may also include, in each of the warm and not-warm domains 202, 204, a reset tree which provides a set of reset signal paths branching out from either the warm reset pin 208 or the cold reset pin 210 to propagate the corresponding reset signal to each component in the corresponding reset domain (e.g. the warm or not-warm domain), to trigger the resetting of the state of those components. The reset circuitry 201 is an example of reset circuitry responsive to a cold reset trigger event to perform a cold reset by resetting the processing circuitry and responsive to a warm reset trigger event to perform a warm reset by resetting a subset of state that is reset in response to the cold reset trigger event.

In the example of FIG. 2, the warm reset domain 202 includes the warm reset configuration value (BREW) 140 and various other warm domain state, such as a watchdog timer 212. A watchdog timer (also referred to as a computer operating properly or COP timer) is a timer that is used to detect malfunctions. In particular, the CPU is configured, during normal operation, to regularly restart the watchdog timer to prevent it from elapsing (counting down to zero). If the CPU fails to restart the watchdog timer (e.g. due to an error), the timer will elapse and generate a timeout signal. The timeout signal is used to initiate corrective actions—for example, the watchdog timer elapsing may be a warm reset trigger, and thus may trigger a warm reset. For example, on a warm reset the power to the integrated circuit may remain on, so that state that is not in the warm reset domain retains its current values.

On the other hand, the not-warm reset domain 204 in FIG. 2 includes the cold reset configuration value 138, the branch record buffer 144 and various other warm domain state, such as debug state 214 (e.g. state relating to debug processes carried out by the CPU).

Generally, the not-warm reset domain 204 might include state which needs to be maintained after a warm reset, but not after a cold reset. For example, the branch record buffer 144 is in the not-warm domain 204, because it may store branch records generated prior to a warm reset, which might be needed for diagnostic processes to diagnose the cause of the warm reset (e.g. the cause of the watchdog timer 212 elapsing). Similarly, the debug state 214 is also in the not-warm domain 214, because debugging after a warm reset may require access to debug state stored prior to the warm reset.

The state in each of the reset domains may comprise flip-flops, which are reset to a default state (e.g. this could be a value of 0, although this is just one example—in other examples, the default state may be 1, for example). Similarly, each of the warm and cold reset configuration values 138, 140 may be responsive to a reset signal to reset to a default value (again, this could be 1 or 0, for example, depending on the particular implementation).

It will be appreciated that each of the warm domain 202 and the not-warm domain 204 may also contain other state not shown in FIG. 2.

As shown in FIG. 2, optionally, a reset value selecting signal can be supplied to control whether the cold reset branch recording configuration value 138 is reset to 1 or 0. The reset value selecting signal could be supplied at a cold reset branch recording configuration signal pin 216 from an external device external to the integrated circuit comprising the cold domain 206, or could be generated by logic on another part of the integrated circuit that is outside the cold domain 206. This allows configuration of whether, after a cold reset, branch recording is enabled by default or disabled by default in the period between the cold reset and the time when software executed by the processing circuitry configures the values of BREC 138 and BREW 140. The provision of the reset value selecting signal is optional, and other examples may simply reset BREC 138 to a fixed one of 0 or 1 so that it is fixed whether or not branch recording is enabled after the cold reset.

As mentioned above, the BREC and BREW values 138, 140 can be set by a programmer to control branch recording by the branch recording circuitry 142 around a warm reset. FIG. 3 shows an example of how this may be implemented.

In the example of FIG. 3, the BREC and BREW values can each be set to either 1 or 0, and are each configured to be reset to 0 in response to a reset signal. The branch recording circuitry 142 is configured to enable branch recording when the BREC and BREW values are different (e.g. when BREC !=BREW), and to disable branch recording when the BREC and BREW values are equal (BREC==BREW).

The table in FIG. 3 illustrates the values to which the programmer can set the BREC and BREW values, in order to select various branch recording configurations. In other words, the table shows what the BREC and BREW values will be from when they are set by the programmer to when a warm reset occurs, at which point the BREW value will be reset to 0. As shown in the first row of the table in FIG. 3, the programmer can set the BREC value to 0 and the BREW value to 1 to control the branch recording circuitry to enable branch recording up until a warm reset, and to disable branch recording after the warm reset (e.g. a “stop at warm reset” configuration). In particular, branch recording will be enabled prior to the reset since the programmer has set the values of BREC and BREW to be different (0 and 1). However, branch recording will be disabled after a warm reset, since the BREW value is reset to 0 at the warm reset, such that the BREC and BREW values are equal after the reset (both are 0).

As shown in the second row of the table in FIG. 3, in order to control the branch recording circuitry to enable branch recording at a warm reset (e.g. a “start at warm reset” configuration), the programmer sets both the BREC and BREW values to 1. In this way, branch recording is disabled prior to the warm reset, because the BREC and BREW values are equal (both are 1), but will be enabled after the warm reset, since the BREW value will be reset to 0, such that the BREC and BREW values are no longer equal (1 and 0).

Hence, for both the “stop at warm reset” and “start at warm reset” configurations, the BREW value is set to 1 (or, more generally, to a non-reset value), so that the state indicated by the BREC and BREW values changes at a warm reset value (e.g. because the BREW value changes to the reset value (e.g. 0) at the warm reset). However, it will be appreciated that these values are specific to implementations where branch recording is enabled when BREC !=BREW.

Referring to the third row of the table in FIG. 3, in order to control the branch recording circuitry to record through a warm reset (e.g. to enable branch recording both before and after the warm reset—referred to as “record through warm reset”), the programmer sets the BREC value to 1, and the BREW value to 0. In this way, branch recording is enabled both before the warm reset and after the warm reset, because the BREW and BREC values are not equal (1 and 0), and because neither value changes at the warm reset.

Finally, to control the branch recording circuitry to not perform branch recording at all, the programmer sets both the BREC and BREW values to 0. In this way, branch recording is disabled both before and after the warm reset, because the BREC and BREW values are equal (both 0), and because neither value changes at a warm reset. Since both the BREC and BREW values are reset to 0 at a cold reset, the default state after a cold reset is to disable branch recording.

Hence, for both the “record through warm reset” and “do not record” configurations, the BREW value is set to 0 (or, more generally, to a reset value), so that the state indicated by the BREC and BREW values does not change at a warm reset value (e.g. because the BREW value is already the reset value (e.g. 0) prior to the warm reset). However, it will be appreciated that this is only the case in implementations where branch recording is disabled when BREC==BREW.

As noted above, the table in FIG. 3 shows how a programmer can control branch recording before and after a reset in implementations where branch recording is performed when BREC !=BREW, and when both the BREC and BREW values are reset to 0 on a cold reset (and also on a warm reset, in the case of the BREW value). In alternative implementations where both the BREC and BREW values are reset to 1, then the values of 0 and 1 in the table are simply replaced with 1 and 0 respectively.

FIG. 4 shows how software can set each of the configurations shown in FIG. 3, and how a warm reset affects the BREC and BREW values. In the diagram of FIG. 4, the BREC and BREW values (identified as “E3BREC” and “E3BREW” in FIG. 4, to indicate that these values only control branch recording for processes executed at exception level 3, as will be discussed in more detail below) are initially both 0—for example, this could be following a cold reset, which resets both values to 0, or it could be because the programmer has turned off branch recording by setting both values to 0.

In the “enable” step, the software enables branch recording in one of the configurations described above. In particular, to select the “stop at reset” state, the software sets the BREW value to 1. This enables branch recording, since BREC !=BREW. To select the “record through reset” configuration, the software sets the BREC value to 1; this also enables branch recording, since BREC !=BREW. To select the “start at reset” state, the software sets both BREC and BREW to 1; this disables branch recording (or rather, does not enable branch recording, since it was already disabled), since BREC==BREW. Finally, (not shown in FIG. 4 for conciseness) the software can maintain a “do not record” configuration by leaving the BREC and BREW values as they are (e.g. both set to 0).

On a warm reset, the BREW value is reset to 0, but the BREC value remains unchanged. This means that the BREC and BREW values will indicate one of two possible states after a warm reset: a state in which BREC=1 and BREW=0, so that BREC !=BREW and branch recording is enabled; and a state in which BREC=0 and BREW=0, so that BREC==BREW and branch recording is disabled. In particular, when the software has selected the stop at reset configuration (BREC=0 and BREW=1 before the warm reset), branch recording will be disabled following a reset. When the software has selected the record through reset configuration (BREC=1 and BREW=0 before the warm reset), branch recording will remain enabled after the warm reset. When the software has selected the start at reset configuration (BREC=1 and BREW=1 before the warm reset), branch recording will be enabled at the warm reset. Finally, although not shown in the diagram, it will be appreciated that if the software selects the do not record configuration (e.g. leaving both the BREC and BREW values at 0 before the warm reset), branch recording will continue to be disabled after the warm reset.

FIG. 5 illustrates yet another example implementation, in which the branch recording circuitry is configured to enable branch recording when the BREC and BREW values are equal (unlike in FIGS. 3 and 4, where branch recording is performed when the BREC and BREW values are not equal). In this example, since branch recording is enabled when the BREC and BREW values are equal, the BREW value is set to the non-reset value (e.g. so that the value of BREW changes at a warm reset) to configure both the start at warm reset and stop at warm reset states, and the BREW value is set to the reset value (e.g. so that the value of BREW does not change at a warm reset) to configure both the record through warm reset and do not record states.

In the particular example shown in the table of FIG. 5, the BREC value is reset to 0 on a cold reset, while the BREW value is reset to 1 on both warm and cold resets. Hence, the stop at warm reset state is configured by setting BREC==BREW==1, the start at warm reset state is configured by setting BREC==1 and BREW==0, the record through warm reset state is configured by setting BREC==BREW==1, and the do not record state is configured by leaving both BREC and BREW at their reset values (0 and 1 respectively).

It should be noted that in alternative implementations where both the BREC value is reset to 1 and the BREW value is reset to 0, then the values of 0 and 1 in the table are simply replaced with 1 and 0 respectively.

In each of the examples shown in FIGS. 3-5, four different configurations (stop at warm reset, start at warm reset, record through warm reset, and do not record) are possible, and branch recording both before and after a warm reset can be controlled—even when the branch recording circuitry is configured to act differently before and after a warm reset (e.g. to start or stop branch recording at a warm reset)—using just two values (BREC and BREW). This is possible because: (1) a pair of values provides four different states (e.g. 00, 01, 10, 11); (2) the BREW value is reset on both warm and cold resets, while the BREC value is only reset on cold resets (allowing two of the four states to control the branch recording circuitry to act differently on either side of a warm reset); and (3) the BREC and BREW values can be used to determine whether to perform branch recording by comparing the values (e.g. to see whether or not the values are equal or not equal). Hence, branch recording both before and after the warm reset can be implemented in a configurable manner without requiring any software configuration after the warm reset, allowing a programmer to tailor the process to the particular needs of the system (e.g. depending on the requirements of diagnostic software executing on the CPU or in external diagnostic circuitry, and depending on the relative importance of saving power versus improving performance). Moreover, since just two values (BREC and BREW) are needed to represent all four states, and since it is possible to determine whether to perform branch recording at any given time by comparing the BREC and BREW values (e.g. to determine whether or not they are equal), it is possible to provide these advantages without a significant increase in cost. In particular, the present technique makes use of two configuration values to be programmed to control branch recording, and the circuitry required to determine whether, at any given time, to perform branch recording can be implemented using simple comparison circuitry to compare the two values.

FIG. 6 is a flow diagram showing a method of operation of the branch recording circuitry, under the control of the BREC and BREW values. In the method shown in FIG. 6, it is determined S610 whether a branch instruction is processed. The branch recording circuitry waits (the “N” branch) until a branch instruction is processed (e.g. by the processor pipeline of FIG. 1).

When the branch recording circuitry determines that the processing circuitry is processing a branch instruction (the “Y” arrow; for example, the branch recording circuitry may detect when a branch instruction is fetched by the fetch circuitry, when it is decoded by the decode circuitry or issued by the issue circuitry, or when it is executed by the execution circuitry), it then determines S620 whether the BREC and BREW values satisfy a predetermined condition. For example, as in the examples of FIGS. 3-5, the predetermined condition could be based on whether or not the BREC and BREW values are equal (e.g. in FIGS. 3 and 4, the predetermined condition is that BREC !=BREW, while in FIG. 5, the predetermined condition is that BREC==BREW). Alternatively, any other predetermined condition could be specified for the BREC and BREW values, to indicate that branch recording is to be performed.

If the BREC and BREW values do not satisfy the predetermined condition (the “N” arrow), the method returns to step S610 and the branch recording circuitry waits until another branch instruction is processed.

On the other hand, if the predetermined condition is met (the “Y” arrow), the branch recording circuitry determines at step S622 whether the processed branch is taken. If the branch is not taken, again the method returns to step S610 to await processing of another branch.

If at step S622 it is determined that the branch is taken, then at step S624 the branch recording circuitry determines whether any filter criteria (for determining whether a particular branch should have information recorded in the branch record buffer) are satisfied. For example, the filter criteria could specify one or more types of branches for which branch records should be stored (or one or more types of branches for which branch records should not be stored). Also, the filter criteria could specify one or more address ranges for which branches with instruction addresses (or target addresses) within that range should or should not be stored in the branch record buffer. It is not essential for filter criteria to be specified, and if no filter criteria are currently specified then the outcome at step S622 could always be Y.

Hence, if any filter criteria are satisfied at step S622, then at step S630 the branch recording circuitry records information about the processed branch instruction in the branch record buffer. Step S630 is omitted if any filter criteria being imposed are not satisfied for the current branch. Regardless of whether any information is stored in the branch record buffer, the method then returns to step S610 and the branch recording circuitry waits until another branch instruction is processed.

While FIG. 6 shows a sequential series of steps in a certain order, it will be appreciated that the various checks at steps S620, S622, S624 could be performed in a different order or could be performed at least partially in parallel.

FIG. 7 is a flow diagram showing a method of performing a warm or cold reset in response to a corresponding reset trigger. In the method of FIG. 7, it is determined S710 whether a cold reset trigger (e.g. a power on operation) has been detected. When a cold reset trigger is detected (the “Y” arrow), a cold reset S730 is performed. In particular, the cold reset S730 comprises steps of resetting S740 the “not warm” domain (including the BREC value), and resetting S760 the warm domain. The method then returns to step S710.

On the other hand, if it is determined in step S710 that a cold reset trigger has occurred, it is determined S720 whether a warm reset trigger has occurred. If a warm reset trigger has not occurred (the “N” arrow), the method returns to step S710. On the other hand, if it is determined that a warm reset trigger has occurred (“Y” arrow), the warm domain (including the BREW value) is reset S750, before the method returns to step S710.

Turning now to FIG. 8, this figure schematically illustrates an example of processes which can be executed by a data processing apparatus. A hypervisor 802 may manage a number of virtual machines (VMs, also known as guest operating systems or guest OS) 804. Each VM 804 may manage one or more applications 806. For example the hypervisor 802 may control which regions of an address space are allocated to each virtual machine 804 and control switching between the virtual machines 804, e.g. scheduling interrupts to time share processing resource between the respective virtual machines 804. Similarly, each VM 804 may control which regions of the address space are allocated to each application 806 executing under that VM 804, and may control switching between the applications as required.

As shown in FIG. 8, each process is associated with a given privilege level EL0, EL1, EL2, EL3. In this example higher numbered privilege levels are more privileged than lower numbered privilege levels, although it could be numbered the other way round in other examples (e.g. EL0 could instead denote the most privileged exception level). In this example, the applications 806 execute at privilege level EL0, the VMs 804 execute at privilege level EL1 and the hypervisor 802 executes at privilege level EL2. Typically, a process executing at a higher privilege level has rights not available to a process executing at a lower privilege level.

As shown in FIG. 8, the hypervisor 802, VMs 804 and apparatus 806 may operate in a normal domain. In addition, the apparatus may support a secure domain which is partitioned from the normal domain so that processes executing in the normal domain cannot access data or instructions associated with the secure domain. Hence, there may also be processes running in the secure domain, such as a secure operating system (OS) 810 and trusted applications 812 executing in the secure domain under control of the secure OS 810. The secure OS 810 and trusted applications 812 execute at privilege levels S-EL1, S-EL0 respectively. A secure monitor process 814 is also provided at privilege level EL3 to manage transitions between the normal domain and the secure domain. The secure monitor process 814 may for example manage which regions of the address space are associated with the secure or non-secure domains, with some protection hardware being provided to prevent non-secure processes in the normal domain accessing data or instructions within the secure regions. The secure monitor 814 may also control execution of reset code following a warm or cold reset. An example of a technique for partitioning the normal and secure domains is the Trustzone® technique provided by ARM® Limited of Cambridge, UK, although other examples could also be used. The provision of a secure domain as shown in FIG. 8 is optional and other embodiments may not support the secure monitor 814, secure OS 810 and trusted applications 812 for example. The normal domain and the secure domain are unrelated to (independent of) reset domains such as the warm and not-warm reset domains.

Data associated with higher privilege levels (e.g. data modified by processes executed at higher privilege levels) may be inaccessible to processes executing at lower privilege levels, for example so that less trusted programs cannot access sensitive code and data. For example, it may be desirable to prevent lower-privileged code from accessing branch records generated by the branch recording circuitry while the processing circuitry was executing at a higher-privilege level. This may particularly be the case for branch records generated around a warm reset, since reset firmware (e.g. code executed immediately after reset) will typically be executed at a higher privilege level. Hence, it can be useful to provide some a mechanism to control whether processes executing at less privileged levels than a given privilege level can access the branch record buffer.

For example, the BREC and BREW values may only be accessible to processes executing at EL3, with branch recording being controlled by some other mechanism (e.g. independently of the BREC and BREW values) at lower privilege levels. This prevents any lower-privileged processes from controlling whether information about branches executed at EL3 is stored to the branch record buffer, leading to improved security.

In addition, processes executing at EL0, EL1 or EL2 may be prevented from accessing the branch record buffer. For example, a control value may be provided (for example in one of the control registers 136 shown in FIG. 1), and the processing circuitry may be configured—when the control value is set to a given value—to prevent processes executing at EL0, EL1 or EL2 from accessing the branch record buffer. This also leads to an improvement in security, while also giving the flexibility to allow lower-privileged processes to access the branch record in situations where it would be helpful and safe to do so. On the other hand, in some implementations the control value will not be provided, and processes executing at EL0, EL1 or EL2 may be prevented entirely from accessing the branch record.

FIG. 9 is a flow diagram showing an example of a method for determining whether a currently executing process should be permitted to access the branch record. In the method, it is determined S902 whether a currently-executing process is executing at EL3. If the current exception level is EL3, the processing circuitry is permitted S904 to access the branch record. In addition, when the processing circuitry is executing at EL3, it is determined whether to enable branch recording by determining S906 whether the BREC and BREW values meet a predetermined condition (as discussed above—e.g. the predetermined condition could be BREC !=BREW or BREC==BREW). If the predetermined condition is met, the branch recording circuitry enables S908 branch recording.

On the other hand, if the current exception level is not EL3 (e.g. if the current exception level is a lower exception level such as EL0, EL1 or EL2), the branch recording circuitry is configured to determine S910 whether to enable branch recording independently of the BREC and BREW values (e.g. based on some other condition). In addition, when not executing at EL3, it is determined S912 whether a given control value in a control register has a first value, and if it does, the processing circuitry is prevented S914 from accessing the branch record. On the other hand if the control value has a different (e.g. second) value, the processing is not prevented from accessing the branch record buffer (e.g. the processing circuitry is permitted to access the branch record buffer). The control value is accessible to code operating at EL3 and inaccessible to code operating at less-privileged exception levels, so that updating the given control value is restricted to instructions executed at EL3.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
processing circuitry to process instructions;
reset circuitry responsive to a cold reset trigger event to perform a cold reset by resetting the processing circuitry and responsive to a warm reset trigger event to perform a warm reset by resetting a subset of state that is reset in response to the cold reset trigger event; and
branch recording circuitry to perform branch recording to store, in branch record storage circuitry, information about processed branch instructions;
wherein the branch recording circuitry is configured to:
determine whether warm and cold branch recording configuration values held in at least one register satisfy a predetermined condition; and
when the warm and cold branch recording configuration values satisfy the predetermined condition, enable the branch recording,
wherein the branch record storage circuitry is configured to make the information about the processed branch instruction available for diagnostic analysis, and
wherein the cold reset comprises resetting both of the warm and cold branch recording configuration values, and the warm reset comprises resetting the warm branch recording configuration value and leaving the cold branch recording configuration value unchanged.

2. The apparatus of claim 1, wherein
the branch recording circuitry is configured to determine whether the warm and cold branch recording configuration values held in the at least one register satisfy the predetermined condition based on a comparison of the warm branch recording configuration value with the cold branch recording configuration value.

3. The apparatus of claim 1, wherein
the predetermined condition comprises one of:
the warm and cold branch recording configuration values being equal; and
the warm and cold branch recording configuration values being different.

4. The apparatus of claim 1, wherein:
the at least one register is configurable by software to set the warm and cold branch recording configuration values to one of a plurality of states; and
the warm branch recording configuration value has one of a warm configured value and a warm reset value, and the warm reset and cold reset both comprise resetting the warm branch recording configuration value to the warm reset value.

5. The apparatus of claim 4, wherein
the plurality of states comprise a start-at-reset state, wherein the branch recording circuitry is responsive to the warm and cold branch recording configuration values indicating the start-at-reset state to, in response to the reset circuitry performing the warm reset, enable the branch recording.

6. The apparatus of claim 5, wherein:
the start-at-reset state is indicated by the warm branch recording configuration value having the warm configured value and the cold branch recording configuration value having a first value;
the branch recording circuitry is configured to determine that the predetermined condition is satisfied when the warm branch recording configuration value has the warm reset value and the cold branch recording configuration value has the first value; and
the branch recording circuitry is configured to determine that the predetermined condition is unsatisfied when the warm branch recording configuration value has the warm configured value and the cold branch recording configuration value has the first value.

7. The apparatus of claim 4, wherein
the plurality of states comprise a stop-at-reset state, wherein the branch recording circuitry is responsive to the warm and cold branch recording configuration values indicating the stop-at-reset state to, in response to the reset circuitry performing the warm reset, disable the branch recording.

8. The apparatus of claim 7, wherein:
the stop-at-reset state is indicated by the warm branch recording configuration value having the warm configured value and the cold branch recording configuration value having a second value;
the branch recording circuitry is configured to determine that the predetermined condition is satisfied when the warm branch recording configuration value has the warm configured value and the cold branch recording configuration value has the second value; and
the branch recording circuitry is configured to determine that the predetermined condition is unsatisfied when the warm branch recording configuration value has the warm reset value and the cold branch recording configuration value has the second value.

9. The apparatus of claim 4, wherein
the plurality of states comprise a record-through-reset state, wherein the branch recording circuitry is responsive to the warm and cold branch recording configuration values indicating the record-through-reset state to enable the branch recording both before and after the reset circuitry has performed the warm reset.

10. The apparatus of claim 9, wherein:
the record-through-reset state is indicated by the warm branch recording configuration value having the warm reset value and the cold branch recording configuration value having a first value; and
the branch recording circuitry is configured to determine that the predetermined condition is satisfied when the warm branch recording configuration value has the warm reset value and the cold branch recording configuration value has the first value.

11. The apparatus of claim 4, wherein:
the cold branch recording configuration value has one of a cold configured value and a cold reset value, and the cold reset comprises resetting the cold branch recording configuration value to the cold reset value; and
the branch recording circuitry is configured to determine that the predetermined condition is unsatisfied when the warm branch recording configuration value has the warm reset value and the cold branch recording configuration value has the cold reset value.

12. The apparatus according to claim 4, in which, in response to the cold reset trigger event, the reset circuitry is configured to reset the cold branch recording configuration value to a one of a first value and a second value specified by a reset value selecting signal.

13. The apparatus of claim 1, wherein
the processing circuitry is responsive to a control value held in a control register having a first value to prevent the branch record storage circuitry from being accessed while the processing circuitry is operating at a less privileged execution level than a given execution level.

14. The apparatus of claim 1, wherein
the branch recording circuitry is responsive to the processing circuitry operating at a given execution level to determine whether to enable the branch recording based on the warm and cold branch recording configuration values, and responsive to the processing circuitry operating at a less privileged execution level than the given execution level to determine, independently of the warm and cold branch recording configuration values, whether the branch recording is enabled or disabled.

15. The apparatus of claim 1, wherein
the information about the processed branch instruction comprises information allowing a program flow of processed instructions to be reconstructed.

16. The apparatus of claim 1, wherein
the information about the processed branch instructions comprises at least one of: an instruction address of a processed taken branch instruction; and
a target address of the processed taken branch instruction.

17. The apparatus of claim 1, wherein the branch record storage circuitry is configured to make the information about the processed branch instruction available to at least one of: external diagnostic hardware; and a diagnostic process executing on the processing circuitry.

18. The apparatus of claim 1, wherein:
both of the warm and cold branch recording configuration values are held in the same register.

19. The apparatus of claim 1, wherein the reset circuitry is responsive to the warm reset trigger event to inhibit resetting of the branch record storage circuitry.

20. The apparatus of claim 1, wherein the cold reset trigger event comprises a power-on event.

21. The apparatus of claim 1, wherein the warm reset trigger event comprises a timeout signal generated in response to a watchdog counter elapsing.

22. The apparatus of claim 1, wherein the reset circuitry is responsive to each of a plurality of different warm reset trigger events to reset a different subset of the state that is reset in response to the cold reset trigger event.

23. A method comprising: processing instructions on processing circuitry; performing, in response to a cold reset trigger event, a cold reset by resetting the processing circuitry; performing, in response to a warm reset trigger event, a warm reset by resetting a subset of state that is reset in response to the cold reset trigger event; determining whether warm and cold branch recording configuration values held in at least one register satisfy a predetermined condition; and when the warm and cold branch recording configuration values satisfy the predetermined condition, enabling branch recording, the branch recording comprising storing, in branch record storage circuitry, information about processed branch instructions, wherein the method comprises making the information about the processed branch instruction available for diagnostic analysis, and wherein the cold reset comprises resetting both of the warm and cold branch recording configuration values, and the warm reset comprises resetting the warm branch recording configuration value and leaving the cold branch recording configuration value unchanged.
